(19) United States
(12) Patent Application Publication
(10) Pub. No.: US 2020/0262575 A1
(43) Pub. Date: Aug. 20, 2020

(54) METHOD AND ELECTRONIC DEVICE FOR DETERMINING AT LEAST ONE FUEL CONSUMPTION DOMAIN FOR AN AIRCRAFT, RELATED COMPUTER PROGRAM AND ELECTRONIC DISPLAY SYSTEM

(71) Applicant: THALES, Courbevoie (FR)

(72) Inventors: Florent MENNECHET, Mérignac (FR); Xavier SERVANTIE, Mérignac (FR); Daniel HAURET, Mérignac (FR)

(21) Appl. No.: 16/790,434

(22) Filed: Feb. 13, 2020

(30) Foreign Application Priority Data
Feb. 20, 2019 (FR) 19 01680

(51) Int. Cl. B64D 37/00; G01F 9/02

(52) U.S. Cl. CPC B64D 37/005; G01F 9/023

(57) ABSTRACT

This method for determining at least one fuel cosumption domain for an aircraft is implemented by an electronic device. It comprises acquiring a flight envelope as a function of the altitude and a propulsion variable.

It comprises, for at least one flight phase, calculating a consumption limit curve as a function of the altitude and the propulsion variable, corresponding to a forecasted average consumption for said flight phase; and determining—from the flight envelope and the limit curve—the consumption domain as a function of the altitude and the propulsion variable and including a first consumption subdomain lower than the forecasted consumption for said flight phase and a second consumption subdomain greater than said forecasted consumption, the first and second subdomains being separated by the limit curve.

### CROSS-REFERENCE TO RELATED APPLICATIONS

This application is a U.S. non-provisional application claiming the benefit of French Application No. 19 01680, filed on Feb. 20, 2019, which is incorporated herein by reference in its entirety.

### FIELD

The present invention relates to a method for determining at least one fuel consumption domain for an aircraft, the method being implemented by an electronic determining device.

The invention also relates to a non-transitory computer-readable medium including a computer program including software instructions which, when executed by a computer, implement such a determination method.

The invention also relates to an electronic device for determining at least one fuel consumption domain for an aircraft, and an electronic display system comprising such a determining device.

The invention relates to the field of systems for displaying consumption data of an aircraft, preferably suitable for being embedded in an aircraft, in particular in an aircraft cockpit.

### BACKGROUND

The consumption of the aircraft depends on the altitude. Indeed, the aerodynamic friction decreases with the altitude, and the consumption then decreases. The consumption of the aircraft further depends on a propulsion variable of the aircraft, such as a speed, for example the airspeed, or an engine power of the aircraft.

Managing the consumption is then difficult for the pilot when the aircraft is in a flight phase, where it does not follow a predefined trajectory, that is to say, a flight phase with no predefined flight plan. To manage such a flight phase, the pilot must then estimate the time during which he may fly at a given altitude as a function of a quantity of fuel forecasted for this flight phase. Pilots generally refer to playtime, this expression referring to what can be done with a quantity of fuel allocated for such a flight phase.

However, this estimate requires that the pilot perform complex mental calculations that are demanding in terms of cognitive resources. These calculations are further generally approximate, and then for example lead the pilot to have to shorten said flight phase suddenly, when the aircraft has consumed all of the fuel allocated to this flight phase.

### SUMMARY

The goal of the invention is then to propose a method and an electronic device for determining at least one fuel consumption domain for an aircraft that allow the pilot to anticipate the fuel consumption of the aircraft more easily during at least one flight phase, where it does not follow a predefined trajectory, that is to say, a flight phase with no predefined flight plan, and then to improve the safety of the flight.

To that end, the invention relates to a method for determining at least one fuel consumption domain for an aircraft, the method being implemented by an electronic determining device and comprising the following step:
acquiring a flight envelope of the aircraft, the flight envelope being a function of the altitude and a propulsion variable of the aircraft, and

for at least one respective flight phase, the following steps:
calculating a fuel consumption limit curve as a function of the altitude and the propulsion variable, the consumption limit curve corresponding to an average consumption forecasted for said flight phase, and
determining, from the flight envelope and the consumption limit curve, a fuel consumption domain as a function of the altitude and the propulsion variable, the fuel consumption domain including a first consumption subdomain below the forecasted consumption for said flight phase and a second consumption subdomain above said forecasted consumption, the first and second consumption subdomains being separated by the consumption limit curve.

Thus, the determination, from the flight envelope and the consumption limit curve, of the fuel consumption domain with the first consumption subdomain at the forecasted consumption and the second consumption subdomain above said forecasted consumption allows the pilot to establish, much more easily, whether the instantaneous consumption of the aircraft is below or indeed above the forecasted consumption for said flight phase where the aircraft does not follow a predefined trajectory.

In particular, the pilot can easily determine whether the symbol representative of the instantaneous consumption of the aircraft is in the first subdomain, which then means that the instantaneous consumption of the aircraft is, in light of the instantaneous altitude and propulsion variable of the aircraft, in agreement with the forecasted consumption, or in a corollary manner with the forecasted quantity of fuel, for said flight phase, or if said representative symbol is on the contrary in the second subdomain, which then means that the pilot must act on the altitude and/or the propulsion variable of the aircraft in order to reduce the consumption of the aircraft, so as to comply with the forecasted consumption for said flight phase.

According to other advantageous aspects of the invention, the determination method comprises one or more of the following features, considered alone or according to all technically possible combinations:
the method further comprises a step for displaying, on a display screen, the fuel consumption domain determined for said flight phase;
during the determining step, a symbol representative of an instantaneous consumption of the aircraft is further determined, to be displayed on the fuel consumption domain;
during the determining step, at least one iso-consumption curve is further determined, to be displayed on the fuel consumption domain, each iso-consumption curve corresponding to an average consumption for a flight phase duration modified with respect to that taken into account for calculating the consumption limit curve,

the time variation between the modified duration for a respective iso-consumption curve and the duration taken into account for calculating the consumption limit curve preferably being a multiple of five minute interval(s);
during the determining step, when the propulsion variable is the speed of the aircraft, at least one iso-energy curve is further determined, to be displayed on the fuel consumption domain, each iso-energy curve representing the evolution of the speed as a function of the altitude at constant total energy;
the determining step further includes detecting the presence of a prohibited flight zone for a range of altitude and/or propulsion variable values, to be displayed on the fuel consumption domain;
during the calculating step, the consumption limit curve is calculated via the intersection of a modeled consumption surface for the aircraft and a reference consumption surface for said flight phase,

the modeled consumption surface preferably being predefined and associating an estimated consumption with each propulsion variable and altitude of the flight envelope of the aircraft,

the reference consumption surface preferably being a function of a quantity of fuel forecasted for said flight phase and a forecasted duration of said flight phase,

the reference consumption surface further preferably being a horizontal plane corresponding to a constant consumption, equal to the forecasted quantity of fuel divided by the forecasted duration;
the propulsion variable is chosen from among the group consisting of: a speed of the aircraft, such as the airspeed, and an engine power of the aircraft; and
the forecasted quantity of fuel and/or the forecasted duration of the flight phase are configurable by the pilot.

The invention also relates to a non-transitory computer-readable medium including a computer program including software instructions which, when executed by a computer, implement a determination method as defined above.

The invention also relates to an electronic device for determining at least one fuel consumption domain for an aircraft, the device comprising:
an acquisition module configured to acquire a flight envelope of the aircraft, the flight envelope being a function of the altitude and a propulsion variable of the aircraft,
a calculating module configured, for at least one respective flight phase, to calculate a fuel consumption limit curve as a function of the altitude and the propulsion variable, the consumption limit curve corresponding to an average consumption forecasted for said flight phase, and
a determining module configured, for said at least one respective flight phase, to determine a fuel consumption domain as a function of the altitude and the propulsion variable, from the flight envelope and the consumption limit curve, the fuel consumption domain including a first consumption subdomain below the forecasted consumption for said flight phase and a second consumption subdomain above said forecasted consumption, the first and second consumption subdomains being separated by the consumption limit curve.

The invention also relates to an electronic display system for an aircraft, the system comprising:
a display screen,
a device for determining at least one fuel consumption domain for the aircraft, the determining device being as defined above, and
at least one module for displaying, on the display screen, the fuel consumption domain for at least one respective flight phase.

### BRIEF DESCRIPTION OF THE DRAWINGS

These features and advantages of the invention will appear more clearly upon reading the following description, provided solely as a non-limiting example, and done in reference to the appended drawings, in which:

FIG. 1 is a schematic view of an electronic display system according to the invention, comprising a display screen, a device for determining at least one fuel consumption domain for an aircraft, and a module for displaying the fuel consumption domain on the screen;

FIG. 2 is a schematic view of a fuel consumption domain, determined by the determining device of FIG. 1;

FIG. 3 is a schematic illustration of a model consumption surface for the aircraft and a reference consumption surface for a flight phase, used for calculating a consumption limit curve separating first and second subdomains of the consumption domain of FIG. 2;

FIG. 4 is a view similar to that of FIG. 2, illustrating a shift of the consumption limit curve resulting from an under-consumption situation, then causing an increase in the surface of the first subdomain with respect to that of the second subdomain;

FIG. 5 is a schematic depiction illustrating the taking into account of a prohibited flight envelope for a range of altitude and/or propulsion variable values, the display of this prohibited flight domain on the fuel consumption domain;

FIG. 6 is a schematic view of the display, by the display system of FIG. 1, of two flight phases and their successive fuel consumption domains over the course of the flight of the aircraft, the flight being depicted by a timeline; and

FIG. 7 is a flowchart of a method, according to the invention, for determining at least one fuel consumption domain for an aircraft, the method being carried out by the determining device of FIG. 1.

### DETAILED DESCRIPTION

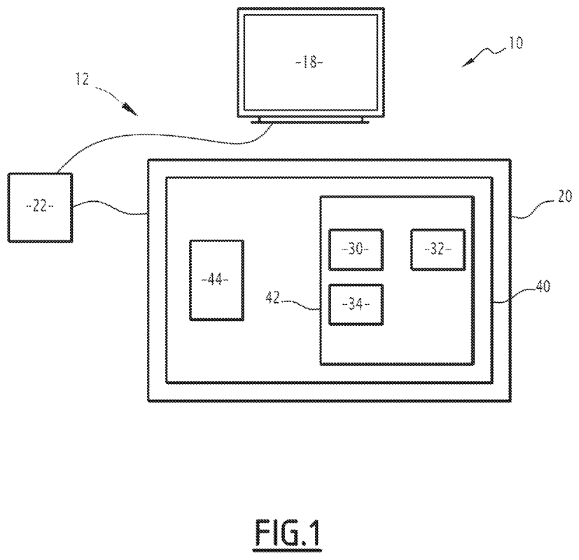

In FIG. 1, an electronic display system 10 is configured to display flight information of an aircraft 12, in particular at least one fuel consumption domain 14.

The electronic display system 10 comprises a display screen 18, an electronic device 20 for determining at least one fuel consumption domain 14 for the aircraft 12, and an electronic display module 22. The electronic display module 22 is coupled, on the one hand, to the display screen 18, and on the other hand, to the electronic determining device 20.

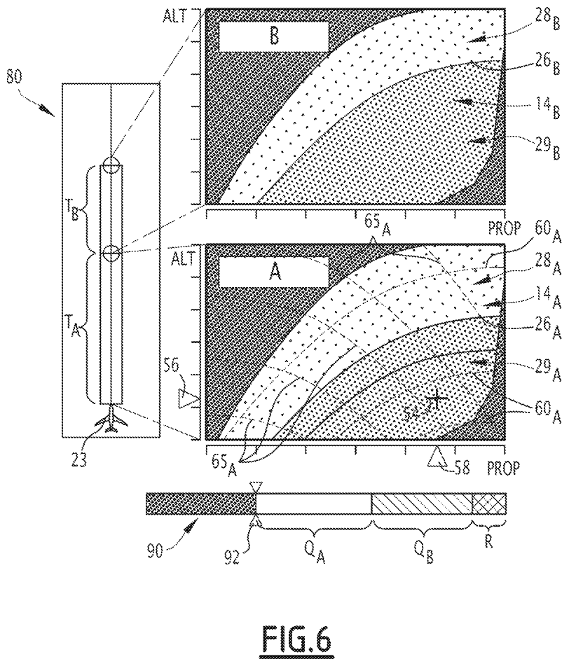

The aircraft 12 is for example an airplane, as shown in FIG. 6, where an aircraft symbol 23 depicting the aircraft 12 is in the shape of an airplane. In a variant, the aircraft 12 is a helicopter. Also in a variant, the aircraft 12 is a drone piloted remotely by a pilot.

Each fuel consumption domain 14 is determined for a respective flight phase of a flight of the aircraft 12, preferably for a flight phase where the aircraft 12 does not follow a predefined trajectory, that is to say, a flight phase with no predefined flight plan.

Each fuel consumption domain 14 is a function of an altitude ALT of the aircraft 12 and a propulsion variable PROP, and is determined from a flight domain 24 and a consumption limit curve 26.

Each fuel consumption domain 14 includes a first consumption C subdomain 28 below a forecasted consumption for the respective flight phase and a second consumption C subdomain 29 above the forecasted consumption for said flight phase, the first 28 and second 29 consumption subdomains being separated by the consumption limit curve 26.

The altitude ALT of the aircraft 12 is typically expressed in feet, also denoted ft.

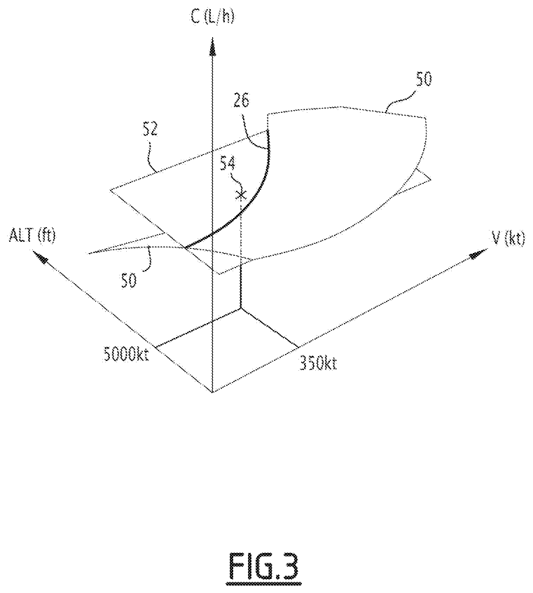

The propulsion variable PROP is chosen from among the group consisting of: a speed V of the aircraft 12, such as the airspeed, and an engine power of the aircraft 12. In the example of FIG. 3, the propulsion variable PROP is a speed V of the aircraft 12, for example its airspeed, and is typically expressed in knots, also denoted kt.

The consumption C of the aircraft 12, whether it involves an estimated consumption or an instantaneous consumption, is typically expressed in liters/hour, also denoted L/h.

The electronic determining device 20 is configured to determine at least one fuel consumption domain 14 for the aircraft 12, and comprises an acquisition module 30, a calculating module 32 and a determining module 34.

In the example of FIG. 1, the electronic determination device 20 comprises an information processing unit 40, for example made up of a memory 42 and a processor 44 associated with the memory 42.

In the example of FIG. 1, the acquisition module 30, the calculating module 32 and the determining module 34 are each made in the form of software, or add-on software, executable by the processor 44. The memory 42 of the electronic determining device 20 is then able to store acquisition software, calculating software and determining software. The processor 44 is then capable of executing each of the software applications from among the acquisition software, the calculating software and the determining software.

In a variant that is not shown, the acquisition module 30, the calculating module 32 and the determining module 34 are each made in the form of a programmable logic component, such as an FPGA (Field Programmable Gate Array), or in the form of a dedicated integrated circuit, such as an ASIC (Application-Specific Integrated Circuit).

When the electronic determining device 20 is made in the form of one or several software programs, i.e., in the form of a computer program, it is further able to be stored on a medium, not shown, readable by computer. The computer-readable medium is for example a medium suitable for storing electronic instructions and able to be coupled with a bus of a computer system. As an example, the readable medium is an optical disc, a magnetic-optical disc, a ROM memory, a RAM memory, any type of non-volatile memory (for example, EPROM, EEPROM, FLASH, NVRAM), a magnetic card or an optical card. A computer program including software instructions is then stored on the readable medium.

The electronic display module 22 is configured to display, on the display screen 18, each fuel consumption domain 14 determined by the electronic determining device 20. The electronic display module 22 is known in itself.

The acquisition module 30 configured to acquire a flight envelope 24 of the aircraft, the flight envelope 24 being a function of the altitude ALT and the propulsion variable PROP of the aircraft 12. The flight envelope 24 is predefined for each respective aircraft 12, generally by the builder of the aircraft 12. The flight envelope 24 is typically stored in a database, not shown.

The calculating module 32 is configured, for at least one respective flight phase, to calculate the fuel consumption limit curve 26 as a function of the altitude ALT and the propulsion variable PROP, the consumption limit curve 26 corresponding to an average consumption forecasted for said flight phase.

The calculating module 32 is, for example, configured to calculate the consumption limit curve 26 via the intersection of a modeled consumption surface 50 for the aircraft 12 and a reference consumption surface 52 for said flight phase, as shown in FIG. 3.

The determining module 34 is configured, for said at least one respective flight phase, to determine a fuel consumption domain 14 as a function of the altitude ALT and the propulsion variable PROP, from the flight envelope 24 and the consumption limit curve 26, the fuel consumption domain 14 including, as previously described, the first consumption C subdomain 28 below the forecasted consumption for said flight phase and the second consumption C subdomain 29 above said forecasted consumption, the first 28 and second 29 consumption subdomains being separated by the consumption limit curve 26.

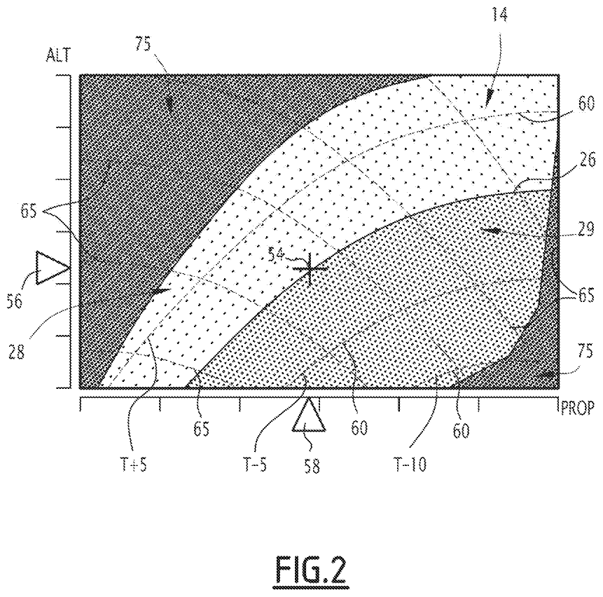

As an optional addition, the determining module 34 is further configured to determine a symbol 54 representative of an instantaneous consumption C by the aircraft 12, this representative symbol 54 being suitable for being displayed on the fuel consumption domain 14, as shown in FIGS. 2 to 6.

As another optional addition, the determining module 34 is further configured to determine a first pointer 56 representing an instantaneous altitude ALT of the aircraft 12 and a second pointer 58 representing an instantaneous propulsion variable PROP of the aircraft 12, as shown in FIGS. 2 and 4 to 6. The skilled person will then understand that the first 56 and second 58 pointers are associated with the representative symbol 54, in that they indicate the instantaneous altitude ALT and instantaneous propulsion variable PROP values leading to the instantaneous consumption C represented by the representative symbol 54 in the fuel consumption domain 14.

As another optional addition, the determining module 34 is further configured to determine at least one iso-consumption curve 60, each iso-consumption curve 60 being suitable for being displayed on the corresponding fuel consumption curve 14. Each iso-consumption curve 60 corresponds to an average consumption for a flight phase duration modified with respect to that taken into account for calculating the consumption limit curve 26.

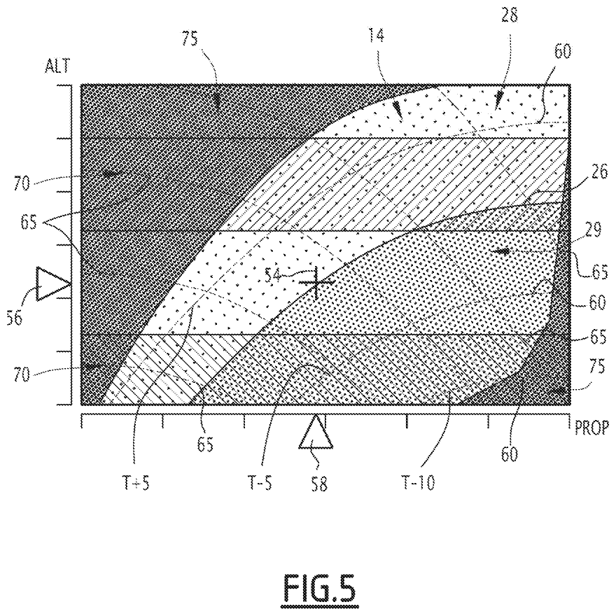

The time variation between the modified duration for a respective iso-consumption curve 60 and the duration taken into account for calculating the consumption limit curve 26 is preferably a multiple of five minute interval(s), as shown in FIGS. 2 and 5, where the iso-consumption curves 60 are shown in dotted lines. In the examples of FIGS. 2 and 5, three separate iso-consumption curves 60 are displayed, namely a first iso-consumption curve 60 associated with the indication “T+5” and corresponding to an average consumption for a flight phase duration increased by 5 minutes with respect to that taken into account for calculating the consumption limit curve 26; a second iso-consumption curve 60 associated with the indication “T−5” and corresponding to an average consumption for a flight phase duration reduced by 5 minutes with respect to that taken into account for calculating the consumption limit curve 26; and a third iso-consumption curve 60 associated with the indication “T−10” and corresponding to an average consumption for a flight phase duration reduced by 10 minutes with respect to that taken into account for calculating the consumption limit curve 26.

As another optional addition, when the propulsion variable PROP is the speed V of the aircraft 12, the determining module 34 is further configured to determine at least one iso-energy curve 65, each iso-energy curve 65 being suitable for being displayed on the corresponding fuel consumption domain 14 and representing the evolution of the speed V as a function of the altitude ALT with constant total energy.

Constant total energy means that the total energy, that is to say, the sum of the kinetic energy (related to the speed V) and the potential energy (related to the altitude ALT), does not vary, while allowing variations of the kinetic energy and the potential energy.

In other words, in order to have such a constant total energy, an increase in the kinetic energy resulting from an increase in the speed V will be offset by a decrease in the potential energy, implying a decrease in the altitude ALT. This explains the general appearance of the iso-energy curves 65 shown in dotted lines in the examples of FIGS. 2, 5 and 6, where along each iso-energy curve 65, the altitude ALT decreases when the propulsion variable PROP increases, considering that the propulsion variable PROP is the speed V in this case.

Conversely, in order to have such a constant total energy, a decrease in the kinetic energy resulting from a decrease in the speed V will be offset by an increase in the potential energy, implying an increase in the altitude ALT.

These iso-energy curves 65 then make it possible to determine the altitude to which it is possible to climb without increasing the total energy of the aircraft.

As another optional addition, the determining module 34 is further configured to update the fuel consumption domain 14 dynamically, in particular the first 28 and second 29 consumption subdomains and the consumption limit curve 26, and, as an optional addition, the position of the representative symbol 54. In other words, the determining module 34 is further configured to determine the fuel consumption domain 14 regularly during the respective flight phase, in particular as a function of previous values of the consumption C of the aircraft 12 during this flight phase.

The skilled person will then understand that if the symbol 54 representative of the instantaneous consumption is in the first subdomain 28 at a distance from the fuel consumption limit curve 26, that is to say, if the aircraft 12 is in the under-consumption configuration for the respective flight phase, this then tends to increase the expanse of the first subdomain 28 with respect to that of the second subdomain 29, that is to say, to bring the fuel consumption limit curve 26 closer to the lower right corner in the examples of FIGS. 2 and 4 to 6. In FIGS. 2 and 4 to 6, the lowest altitude ALT and propulsion variable PROP values respectively correspond to the bottom of the altitude scale ALT and to the left of the propulsion variable scale PROP. Conversely, if the representative symbol 54 is in the second subdomain 29 at a distance from the fuel consumption limit curve 26, that is to say, if the aircraft 12 is in the over-consumption configuration for the respective flight phase, this then tends to increase the expanse of the second subdomain 29 with respect to that of the first subdomain 28, that is to say, to bring the fuel consumption limit curve 26 closer to the upper left corner in the examples of FIGS. 2 and 4 to 6. Lastly, if the representative symbol 54 is on the fuel consumption limit curve 26, that is to say, if the consumption C of the aircraft 12 conforms with the forecasted consumption for said flight phase, then the first 28 and second 29 subdomains and the consumption limit curve 26 do not vary.

Also as an optional addition, the determining module 34 is further configured to detect whether at least one no-fly zone 70 for a range of altitude ALT and/or propulsion variable PROP values is present, each no-fly zone 70 being suitable for further being displayed on the fuel consumption domain 14, as shown in FIG. 5.

In the example of FIG. 5, two separate no-fly zones 70 are shown, each in the form of a crosshatched area. In this example of FIG. 5, a first no-fly zone 70 corresponds to a range of low altitude values ALT and for any propulsion variable value PROP of the aircraft 12; and a second no-fly zone 70 corresponds to a higher range of altitude values ALT and also for any propulsion variable value PROP.

As another optional addition, the determining module 34 is further configured to determine areas outside the flight envelope 75 from the acquired flight envelope 24. In the examples of FIGS. 2 and 4 to 6, the areas outside the flight domain 75 are the dark areas outside the fuel consumption domain 14.

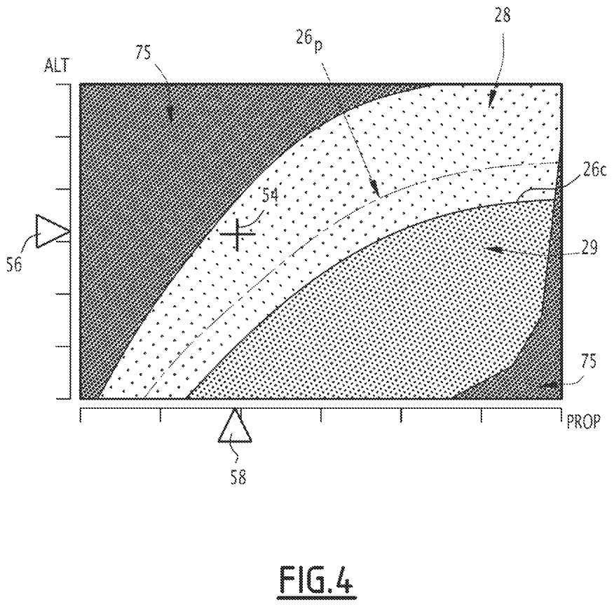

As another optional addition, the determining module 34 is further configured to determine a history of successive fuel consumption limit curves 26, a preceding fuel consumption limit curve 26_{P} then being suitable for being displayed on the fuel consumption domain 14 in addition to the display of a current fuel consumption limit curve 26_{C}, as shown in FIG. 4. In the example of FIG. 4, the preceding fuel consumption limit curve 26_{P} is shown in broken (or mixed) lines, and the current fuel consumption limit curve 26_{C} is shown in continuous lines.

The skilled person will note that this example of FIG. 4 corresponds, for the current fuel consumption limit curve 26_{C}, to an under-consumption configuration with respect to the preceding situation associated with the preceding fuel consumption limit curve 26_{P}. Indeed, the first subdomain 28 corresponding to the preceding fuel consumption limit curve 26_{P} has a smaller scope than that henceforth corresponding to the current fuel consumption limit curve 26_{C}, such that the variation of the fuel consumption limit curve 26 has caused an increase in the scope of the first subdomain 28, which reflects a lower consumption.

The modeled consumption surface 50 is preferably predefined and associates an estimated consumption C with each propulsion variable PROP and altitude ALT of the flight envelope 24 of the aircraft 12.

The modeled consumption surface 50 is for example developed experimentally by taking consumption measurements for different pairs of propulsion variable PROP and altitude ALT values, or developed from an equation supplied by the builder of the aircraft 12.

The reference consumption surface 52 is preferably a function of a quantity of fuel forecasted for said flight phase and a forecasted duration of said flight phase.

In the example of FIG. 3, the reference consumption surface 52 is a horizontal plane corresponding to a constant consumption C and equal to the forecasted quantity of fuel divided by the forecasted duration.

As an optional addition, the forecasted quantity of fuel and/or the forecasted duration of the flight phase are configurable by the pilot of the aircraft 12. The skilled person will then understand that a variation of the forecasted quantity of fuel and/or a variation of the forecasted duration modifies the fuel consumption limit curve 26, and therefore the scope, that is to say, the surface, of each of the first 28 and second 29 consumption subdomains.

In particular, an increase in the forecasted duration or a reduction in the forecasted quantity of fuel causes a decrease in the expanse of the first subdomain 28 and, as a corollary, an increase in the expanse of the second subdomain 29. Conversely, a reduction in the forecasted duration or an increase in the forecasted quantity of fuel causes an increase in the expanse of the first subdomain 28 and, as a corollary, a decrease in the expanse of the second subdomain 29.

According to one additional aspect, the electronic determining device 20 according to the invention is configured to determine several successive fuel consumption domains 14 during the flight of the aircraft 12, each fuel consumption domain 14 being associated with a respective flight phase, as shown in FIG. 6.

According to this additional aspect, the electronic determining device 20 is then configured, for each respective flight phase, to calculate—via its calculating module 32—the respective fuel consumption limit curve 26, then to determine, via its determining module 34 and from the flight domain 24 and the calculated consumption limit curve 26, the respective fuel consumption domain 14.

In the example of FIG. 6, the flight is shown by a timeline 80, with a first flight phase having a first forecasted duration T_{A} and a second flight phase having a second forecasted duration T_{B}. A fuel gauge is also shown in FIG. 6, with a first forecasted quantity of fuel Q_{A} for the first flight phase, a second forecasted quantity of fuel Q_{B} for the second flight phase, and a safety reserve R of fuel, this safety reserve R making it possible to ensure safe landing of the aircraft 12. The electronic determining device 20 is then configured to calculate the first fuel consumption limit curve 26_{A}, then to determine the first fuel consumption domain 14_{A}, then the subdomains 28_{A}, 29_{A} and any associated iso-consumption 60A and iso-energy 65_{A} curves for the first flight phase, for example in particular as a function of the first forecasted duration T_{A} and the first forecasted quantity of fuel Q_{A}. The electronic determining device 20 is—next or in parallel—configured to calculate the second fuel consumption limit curve 26_{B}, then to determine the first fuel consumption domain 14_{B}, then the subdomains 28_{B}, 29_{B} and any associated iso-consumption curves for the second flight phase, for example in particular as a function of the second forecasted duration T_{B} and the second forecasted quantity of fuel Q_{B}. The display module 22 is next configured to display, on the display screen 18, the different aforementioned elements for the first and second flight phases.

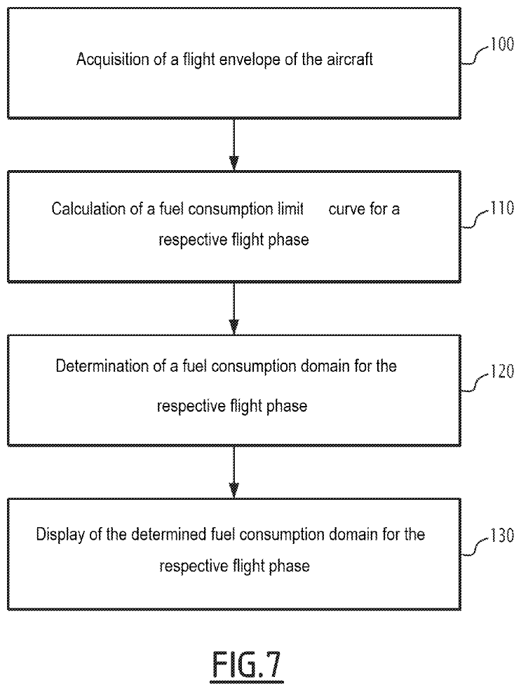

The operation of the electronic determining device 20 will now be explained using FIG. 7, showing a flowchart of the method, according to the invention, for determining at least one fuel consumption domain 14 for the aircraft 12, the method being implemented [sic] the determining device 20.

During an initial step 100, the determining device 20 acquires, via its acquisition module 30, the flight envelope 24 of the aircraft 12.

Then, for at least one respective flight phase, and for each respective flight phase if applicable, the determining device 20 calculates, via its calculating module 32 and during a following step 110, the respective fuel consumption limit curve 26 as a function of the altitude ALT and the propulsion variable PROP; and next determines, during step 120 and via its determining module 34, the respective fuel consumption domain 14, from the flight envelope acquired during step 100 and the respective consumption limit curve 26 calculated during step 110.

Lastly, the display module 22 displays, on the display screen 18, for at least one respective flight phase, and for each respective flight phase if applicable, the or each fuel consumption domain 14 determined during steps 100 to 120 by the determining device 20.

Thus, with the electronic determining device 20 according to the invention and the associated determining method, the pilot can easily determine whether instantaneous consumption of the aircraft 12 corresponds to the first subdomain 28, which means that the instantaneous consumption of the aircraft is, in light of the instantaneous altitude ALT and propulsion variable PROP of the aircraft 12, in agreement with the forecasted consumption, or in a corollary manner with the forecasted quantity of fuel, for said flight phase, or on the contrary if the instantaneous consumption of the aircraft 12 corresponds to the second subdomain 29, which then means that the pilot must act on the altitude ALT and/or the propulsion variable PROP of the aircraft 12 in order to reduce the consumption of the aircraft 12, so as to comply with the forecasted consumption for said flight phase.

In other words, the fuel consumption domain 14 determined by the determining device 20 according to the invention makes it possible to distinguish easily between the two consumption subdomains 28, 29 separated by the limit curve 26, one—namely the first subdomain 28—being favorable, and the other 29—namely the second subdomain—being unfavorable. The first subdomain 28, which is favorable, shows the set of altitude ALT and propulsion variable PROP configurations in which the aircraft 12 can evolve, while retaining its consumption objective. Conversely, the second subdomain 29, which is unfavorable, shows the set of altitude ALT and propulsion variable PROP configurations in which the aircraft 12 does not respect its consumption objective for the considered flight phase, while being configurations of the flight envelope 24.

Advantageously, the symbol 54 shows the altitude ALT and propulsion variable PROP configuration of the aircraft 12 in real time, that is to say, the instantaneous altitude ALT and propulsion variable PROP configuration of the aircraft 12. The consumption limit curve 26 further evolves dynamically as a function of the consumption history of the aircraft 12: if the symbol 54 stays on the consumption limit curve 26, the subdomains 28, 29 are unchanged; if the aircraft 12 is in under-consumption for the considered flight phase, then the first favorable subdomain 28 extends; and if the aircraft 12 is in over-consumption for the considered flight phase, then the second unfavorable subdomain 29 extends, and the pilot must then react accordingly.

Also advantageously, the pilot can dynamically configure the duration and the quantity of fuel allocated to the flight phase, or mission, in question. The quantity of fuel can be a quantity allocated to the mission in progress, the total quantity of fuel, or the total quantity from which the quantity of fuel allocated to the next mission is subtracted. The pilot can also configure the following flight phase in the same manner, which will modify his flight in progress.

Also advantageously, the iso-consumption curves 60 allow the pilot to easily situate different altitude ALT and propulsion variable PROP configurations, which will make it possible to save or lose time with respect to the initially forecasted duration. The values of these gain(s), and respectively these loss(es), are further signaled via the time indications, such as “T+5”, or “T+10”, and respectively T−5″, or “T−10”.

Also advantageously, the iso-energy curve(s) 65 make it possible to go easily from the over-consumption domain, that is to say, the second subdomain 29, to the reduced consumption domain, that is to say, to the first subdomain 28, simply by increasing and decreasing the speed, by following these iso-energy curves 65. In other words, this allows the pilots to determine how to reach the first favorable reduced consumption subdomain 28 by minimizing consumption during the transitional period toward this first subdomain 28, in the case at hand by reducing the kinetic energy in favor of an increase in potential energy, at constant total energy.

Also advantageously, areas to be avoided, namely prohibited zones 60, for example with indicated altitude limitations (no-fly zone) and minimum speed limits, are also determined.

One can then see that the determining method and the electronic determining device 20 according to the invention make it possible for the pilot to more easily anticipate the fuel consumption of the aircraft 12, in particular during each flight phase where the aircraft 12 does not follow a predefined trajectory, and then to improve the safety of the flight.

1. A method for determining at least one fuel consumption domain for an aircraft, the method being implemented by an electronic determining device and comprising:
acquiring, a flight envelope of the aircraft, the flight envelope being a function of the altitude and a propulsion variable of the aircraft, and
for at least one respective flight phase:
calculating a fuel consumption limit curve as a function of the altitude and the propulsion variable, the consumption limit curve corresponding to an average consumption forecasted for said flight phase, and
determining, from the flight envelope and the consumption limit curve, a fuel consumption domain as a function of the altitude and the propulsion variable, the fuel consumption domain including a first consumption subdomain below the forecasted consumption for said flight phase and a second consumption subdomain above said forecasted consumption, the first and second consumption subdomains being separated by the consumption limit curve.

2. The method according to claim 1, wherein the method further comprises displaying, on a display screen, the fuel consumption domain determined for said flight phase.

3. The method according to claim 2, wherein, during the determining, a symbol representative of an instantaneous consumption of the aircraft is further determined, to be, displayed on the fuel consumption domain.

4. The method according to claim 2, wherein, during the determining, at least one iso-consumption curve is further determined, to be displayed on the fuel consumption domain, each iso-consumption curve corresponding to an average consumption for a flight phase duration modified with respect to that taken into account for calculating the consumption limit curve.

5. The method according, to cairn 4, wherein the time variation between the modified duration for a respective iso-consumption curve and the duration taken into account for calculating the consumption limit curve is a multiple of five minute interval(s).

6. The method according to claim 2, wherein, during the determining, when the propulsion variable is the speed of the aircraft, at least one iso-energy curve is further determined, to be displayed on the fuel consumption domain, each iso-energy curve representing the evolution of the speed as a function of the altitude at constant total energy.

7. The method according to claim 2, wherein the determining further includes detecting the presence of a prohibited flight zone for a range of altitude and/or propulsion variable values, to be displayed on the fuel consumption domain.

8. The method according to claim 1, wherein, during the calculating, the consumption limit curve is calculated via the, intersection of a modeled consumption surface for the aircraft and a reference consumption surface for said flight phase.

9. The method according to claim 8, wherein the modeled consumption surface is predefined and associates an estimated consumption with each propulsion variable and altitude of the flight envelope of the aircraft.

10. The method according to claim 8, wherein the reference consumption surface is a function of a quantity of fuel forecasted for said flight phase and a forecasted duration of said flight phase.

11. The method according to claim 10, wherein the reference consumption surface is a horizontal plane corresponding to a constant consumption, equal to the forecasted quantity of fuel divided by the forecasted duration,

12. The method according to claim 1, wherein the propulsion variable is chosen from among the group consisting of: a speed of the aircraft and an engine power of the aircraft.

13. A non-transitory computer-readable medium including a computer program comprising software instructions which, when executed by a computer carry out a method according to claim 1.

14. An electronic device for determining at least one fuel consumption domain for an aircraft, the device comprising:
an acquisition module configured to acquire a flight envelope of the aircraft the flight envelope being a function of the altitude and a propulsion variable of the aircraft,
a calculating module configured, for at least one respective flight phase, to calculate a fuel consumption limit curve as a function of the altitude and the propulsion variable, the consumption limit curve corresponding to an average consumption forecasted for said flight phase, and
a determining module configured, for said at least one respective flight phase, to determine a fuel consumption domain as a function of the altitude and the propulsion variable, from the flight envelope and the consumption limit curve, the fuel consumption domain including a first consumption subdomain below the forecasted consumption for said flight phase and a second consumption subdomain above said forecasted consumption, the first and second consumption subdomains being separated by the consumption limit curve.

15. An electronic display system for an aircraft, the system comprising:
a display screen,
an electronic device for determining at least one fuel consumption domain for the aircraft, and
at least one module for displaying, on the display screen the fuel consumption domain for at least one respective flight phase,
wherein the device is according to claim 14.
